(19) United States
(12) Patent Application Publication
(10) Pub. No.: US 2005/0084417 A1
(43) Pub. Date: Apr. 21, 2005

(54) Parallel structure of centrifugal tubular slide body and related apparatus

(76) Inventor: Jun-Tai Liu, Taoyuan Hsien (TW)

Correspondence Address: Jun-Tai Liu, P. O. Box No. 6-57, Junghe, Taipei, 235, TW

(21) Appl. No.: 10/685,386

(22) Filed: Oct. 16, 2003

(51) Int. Cl. B01D 33/15

(52) U.S. Cl. 422/57; 422/72; 210/512.1

(57) ABSTRACT

A parallel centrifugal tubular slide structure mainly set a plurality of tubular slide bodies positioned in parallel on a plate. A bigger mixture space is at one end of each tubular slide body and a thin slide stiffener at the other end thereof. At the middle of the tubular slide body forms a middle space separated from the mixture space and the thin slide stiffener by two sloping baffle plates, of which the two ends have chinks to enable test solution flows through. The invention enables the result of test solutions to be seen by sight applying centrifugal force to accelerate the separation operation of test solutions in mixture spaces of test tubes. Moreover, the invention enables the test solutions to be observed by microscope making test solutions flow into the opposite direction of the thin slide stiffener by holding the tubular slide bodies for switching in reverse.

### BACKGROUND OF THE INVENTION

(A) Field of Invention

The present invention relates to a parallel structure of a centrifugal tubular slide body and related apparatus, specifically, a structure that is small and convenient for increasing the examination efficiency by effectively simplifying the steps of separating test solution and microscopic examinations.

(B) Description of Prior Art

Traditional applied centrifugal separation devices to medical examinations or chemical analyses set a plurality of wells on a plate that is rotatable driven by a kind of electric power. Those wells are aslope and extended outwards from the center of a circle to allow respective insertions of single test tubes containing test solutions, which flow downwards and aslant to the bottom of test tubes without leakages. Test solutions in respective test tubes, after under high-speed plate rotation, can be fully separated for further examination processes, within which the most frequent way is to singly extract separated solutions out on glass slides for microscopic examinations.

However, the aforesaid conventional centrifugal separation devices are inconvenient to use. Take the microscopic examinations of separated test solutions as an example, the main operation steps require test solutions to be respectively dropped into test tubes, which are, then, seriatim inserted into the wells on the said plate. The repetitious operations not only waste manpower and time, but also cause mistakes easily. Not until prior procedures for test solutions are proceeded, e.g., test solutions have to be extracted from respective test tubes, separately put on microscope slides, then covered with individual cover glasses and clearly labeled, then microscopic examinations can be carried out. The kind of repetitious processes are of no economic benefits.

In view of the foregoing drawbacks of conventional centrifugal separation devices, the present invention provides an improved parallel structure of centrifugal tubular slide body herein.

### SUMMARY OF THE INVENTION

The invention, a parallel structure of centrifugal tubular slide body, mainly sets plurality of parallel tubular slide bodies on a plate. Each tubular slide body has a bigger mixture space for mingled test solutions at one end, a thinner slide stiffener at the other end and utilizes two sloping baffle plates for forming a middle space in between the mixture space and the thin slide stiffener. The chinks/gaps at both ends of each sloping baffle plate enable liquids flow in a fixed direction forming the homogenization characteristic of easily-in-but-hard-out flows. The structure enables test solution in each test tube easily flows into the mixture space and the operation of centrifugal force for accelerating the separation operation make the result to be observed by sight. In addition, the tubular slide body can be held by hand and switched in reverse, so that test solution in the tubular slide body flows in the opposite direction into the gapping place of the thin slide stiffener to be observed by microscope. Moreover, the method of combining a plurality of tubular slide bodies can effectively simplify the repeated and routine operations of dropping test solutions into test tubes; whereas a combination of the mixture space and the gapping place in the thin slide stiffener further simplifies the movement of extracting the separated test solution from test tubes to be dropped on slides. Therefore, the main object of the invention aims at improving the efficiency of the operations.

Furthermore, the invention provides a related apparatus to the parallel centrifugal tubular slide bodies. The apparatus is a centrifugal plate housing, into which each formation of tubular slide bodies and a plate is embedded, contains parallel troughs from the center extended outwards and positions the mixture spaces of individual tubular slide bodies outwards that help maintain test solutions in the mixture spaces in test tubes in favor of the further separation operations. Therefore, another object of the invention is to provide a combination design of the centrifugal plate and the aforesaid tubular slide bodies for achieving the effectiveness of the operations.

To enable a further understanding of the objective, structural features and function of the present invention, the detailed descriptions of the preferred embodiments are followed by the brief descriptions of the drawings below.

### BRIEF DESCRIPTION OF THE DRAWINGS

FIG. 1 is a plane diagram of an assembly of tubular slide bodies according to the invention;

FIG. 2 is a 3D diagram of an assembly of tubular slide bodies according to the invention;

FIG. 3 is a structural outlook of the tubular slide bodies according to the invention;

FIG. 4 is a 3D broken-away diagram of the tubular slide bodies;

FIG. 5 is an exploded structural diagram of the centrifugal plate of the invention;

FIG. 6 is a preferred embodiment of the perspective diagram of the whole formation of the invention;

FIG. 7 is a movement diagram while test solution flows from the intake into the mixture space according to the invention.

FIG. 8 is a movement diagram while test solution flows from the mixture space into the gapping place of the thin slide stiffener according to the invention;

FIG. 9 is another preferred embodiment of the sloping baffle plate of the invention;

### DETAILED DESCRIPTION OF THE PREFERRED EMBODYMENTS

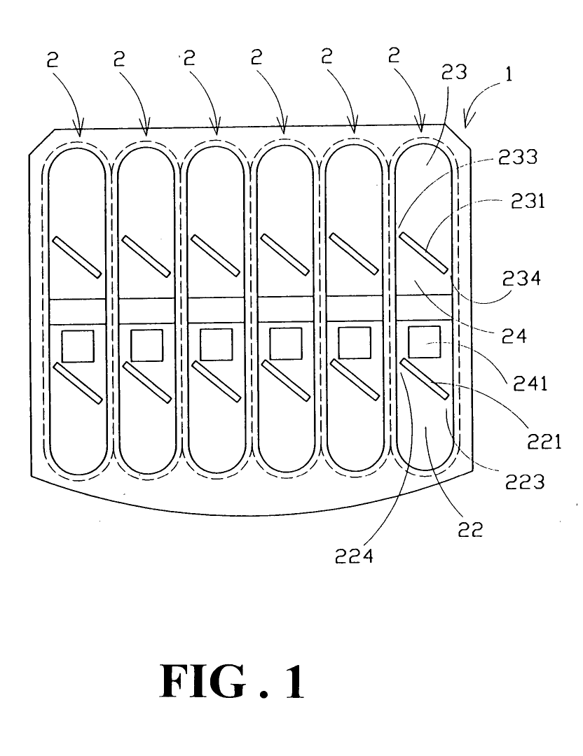

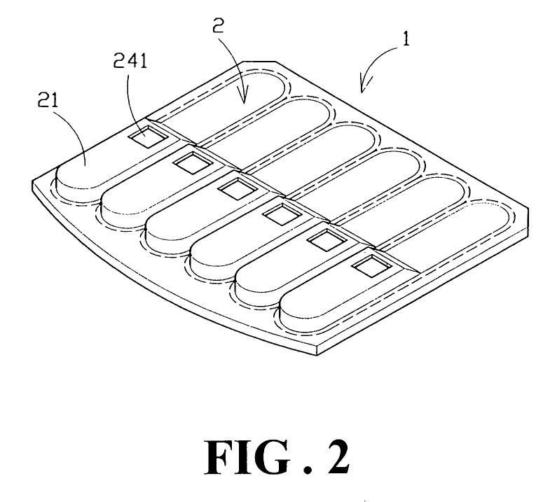

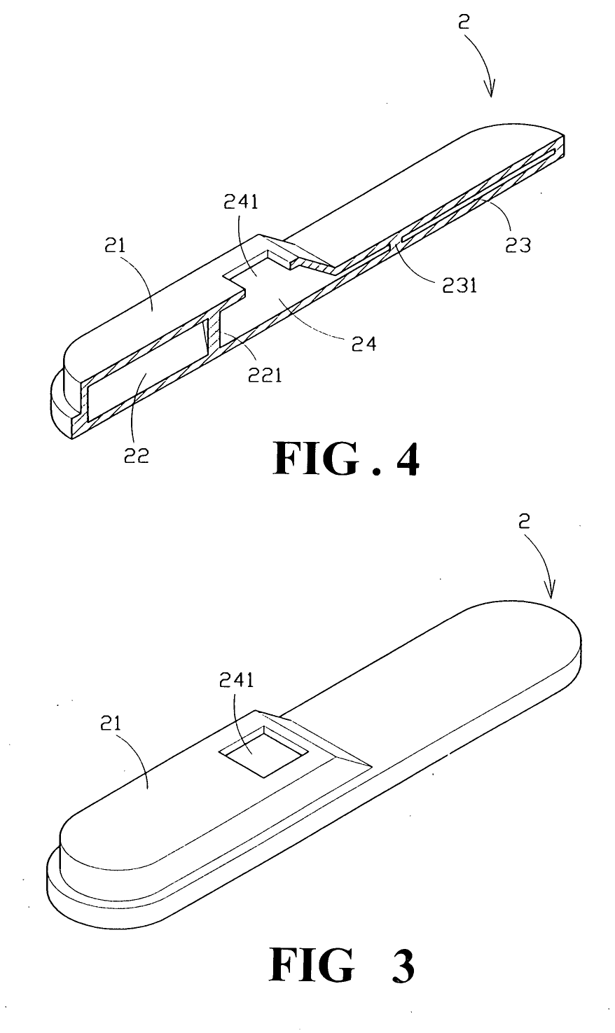

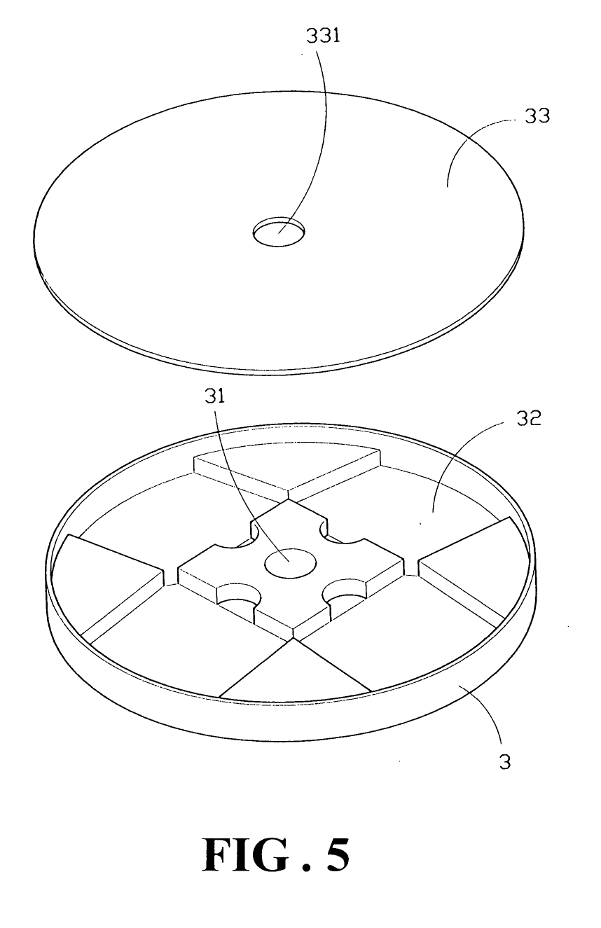

FIGS. 1 to 4 show respective structural diagrams of the tubular slide bodies and the formation thereof, where FIG. 1 illustrates the perspective view of the inner structure of a tubular slide body 2 with removal of the top cover thereof. According to those diagrams, it is clear that the invention sets plurality of tubular slide bodies 2 on a plate 1, where each tubular slide body 2 has a protrusion 21 at one end, inside which is a mixture space 22 and an gapping place in a thin slide stiffener 23 at the other end. A middle space 24, with an intake at the top thereof, is formed between two sloping baffle plates 221 and 231 at the middle of each tubular slide body 2 for partitioning off the mixture space 22 and the thin slide stiffener 23 of each tubular slide body 2. There are gapping places (223 and 224) and (233 and 234) at both ends of sloping baffle plates 221 and 231, respectively.

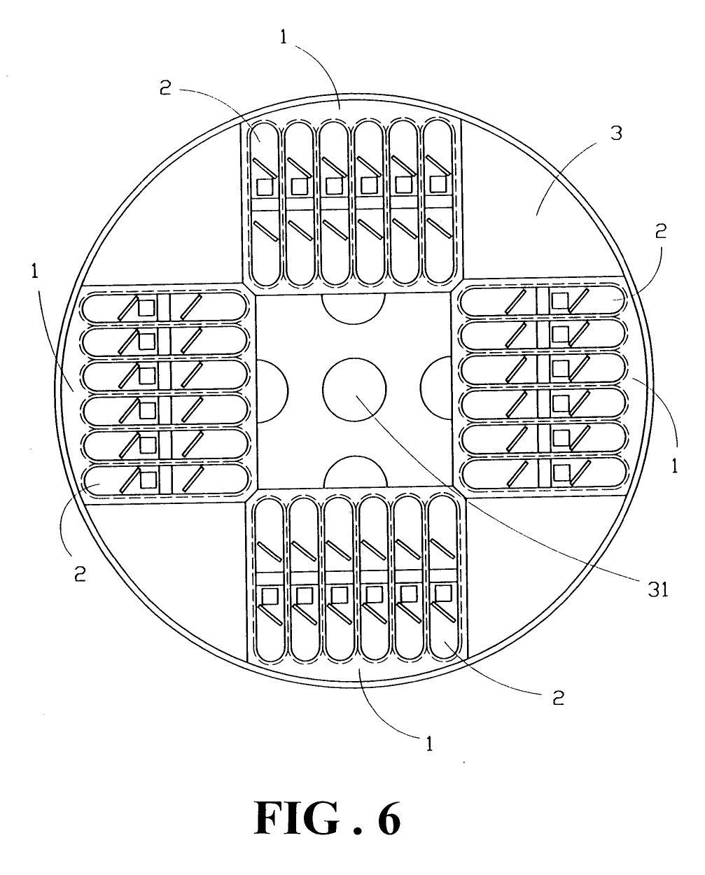

FIG. 5 is the exploded structural diagram of the centrifugal plate and referring to a preferred embodiment of the perspective diagram of the formation as shown in FIG. 6, it is clear that at the center point of the parallel centrifugal plate housing 3 sets a hole 31 for driving through a proper pivot (not shown on the FIGS.) for the rotation purpose. Around the brim of the hole 31, a plurality of troughs 32 radiating are positioned from the center outwards in parallel, so that the edges of the troughs 32 forming a shape for the plate 1 to be embedded. In addition, the top of the parallel centrifugal plate 3 can be covered with a covering body 33, and the mixture space 22 of each tubular slide body is positioned on the lower outside when the plate 1 is embedded and fixed, so that test solution in each mixture space 22 will not overbrim out of the tubular slide body.

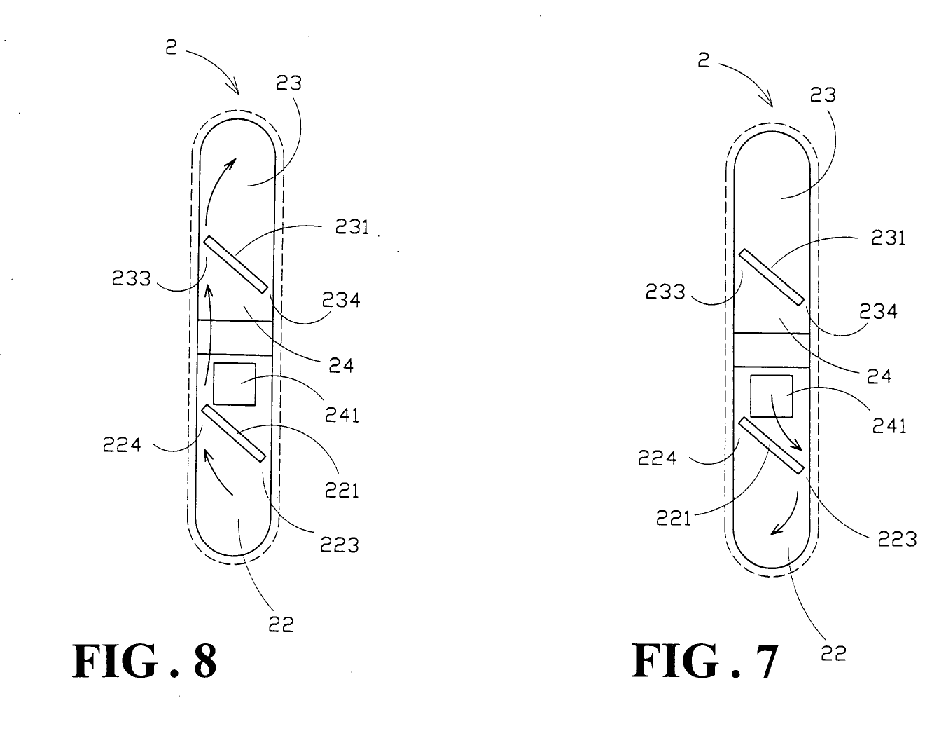

Turning now to FIGS. 7 and 8, both illustrate the diagrams that test solutions flow in tubular slide bodies. A test solution is dropped from an intake 241 into the tubular slide body and quickly flows into the mixture space 22 (as shown on FIG. 7) led by the sloping baffle plate 221 passing through the gap 223 thereof. It forms the flow characteristics of easy-in-but-hard-out for the test solution in the mixture space 22 through the partition of the sloping baffle plate 221 and the slant design of the troughs 32 on the parallel centrifugal plate housing 3, which is used for implementing the separation operation through high-speed rotation. After completion of the separation operation, if the test solution further needs to be observed, it is put into the gapping place in the thin slide stiffener 23 for microscopic observation. To make it happens, the plate 1, then, is withdrew from the trough 32 and held by hand for switching in reverse so that test solution, led by the sloping baffle plate 221, flows from the mixture space 22 into the middle space 24 passing through the gap 224 and into the gapping place in the thin slide stiffener 23 passing through the gap 223 (as shown on FIG. 8).

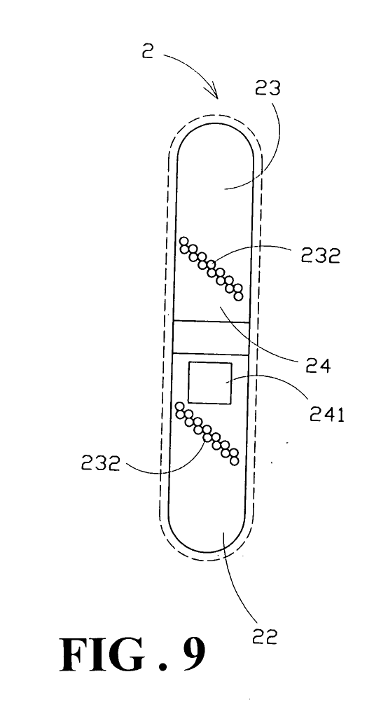

FIG. 9 illustrates another preferred embodiment of the sloping baffle plate structure. It shows that the sloping baffle plates 221 and 231 are formed as a pair of effective structure through appropriate collocation of plurality of raised shafts 222 and 232.

According to the aforementioned descriptions, it is clear that the parrellel centrifugal tubular slide structure and related apparatus truly achieve the improvement of effective examinations with its small size, convenience and standardization. Moreover, the aforesaid structure has not yet been disclosed or claimed, and conforms to the patent laws and regulations filing. Hopefully, the said application is soon to be processed, evaluated and approved.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A parallel centrifugal tubular slide structure at least comprising,
a plate;
a plurality of tubular slide bodies, set in parallel on the plate; at one end of each tubular slide body has a upstanding protrusion, inside which there is a mixture space; at the other end thereof there is a gapping place in a very thin slide stiffener; there are two sloping baffle plates in each tubular slide body forming a middle space in between the mixture space and the thin slide stiffener; both ends of each sloping baffle plate maintain small chinks to allow openings in between the middle space and the mixture space and in between that and the thin slide stiffener; there is an intake on the top of the said middle space.

2. The parallel centrifugal tubular slide structure in accordance with claim 1, wherein the two sloping baffle plates are extended and with the same direction in parallel.

3. The parallel centrifugal tubular slide structure in accordance with claim 1, wherein the two sloping baffle plates are formed through appropriate collocation of a plurality of raised shafts.

4. A parallel centrifugal plate housing for the parallel centrifugal tubular slide structure has a hole at the center thereof for driving a proper pivot through for rotations; around the brim of the hole, a plurality of troughs are positioned in parallel radiating from the brim of the hole outwards; the shape edges of those troughs enable a plate to be embedded.

5. The parallel centrifugal tubular slide structure in accordance with claim 4, wherein the parallel centrifugal plate can be covered with a covering body on the top thereof.
